(19) United States
(12) Patent Application Publication
(10) Pub. No.: US 2020/0346337 A1
(43) Pub. Date: Nov. 5, 2020

(54) Power Tool Device

(71) Applicant: Robert Bosch GmbH, Stuttgart (DE)

(72) Inventors: Bastian Keller, Sontheim (DE); Hardy Schmid, Stuttgart (DE)

(21) Appl. No.: 16/960,043

(22) PCT Filed: Dec. 17, 2018
(86) PCT No.: PCT/EP2018/085136

§ 371 Date: Jul. 3, 2020

(30) Foreign Application Priority Data
Jan. 4, 2018 (DE) 10 2018 200 082.4

(51) Int. Cl. B25F 5/00; B25D 16/00

(52) U.S. Cl. CPC B25F 5/001; B25D 16/006; B25D 2216/0015; B25D 2250/261; B25D 2216/0038; B25D 2250/221; B25D 2216/0023

(57) ABSTRACT

A power tool device, in particular a portable power tool, includes at least one signal switching unit that has at least one signal switching element that is actuable at least in order to activate a drive unit of the power tool. The power tool device further includes at least one operating mode selection unit that has at least one operating mode selection element that is actuable in order to select an operating mode of the drive unit, and at least one locking unit that has at least one locking actuating element at least for locking the signal switching element. The power tool device also includes at least one electronic unit that is configured to control and/or regulate the drive unit at least depending on an evaluation of a setting parameter of the locking actuating element.

### PRIOR ART

There has already been proposed a power-tool device, in particular for hand-held power tools, having at least one signal switching unit that has at least one signal switching element that can be actuated at least for the purpose of activating a drive unit of a power tool, having at least one operating-mode selection unit that has at least one operating-mode selection element that can be actuated for the purpose of selecting an operating mode of the drive unit, and having at least one locking unit that has at least one locking actuating element at least for locking the signal switching element.

### DISCLOSURE OF THE INVENTION

The invention is based on a power-tool device, in particular for hand-held power tools, having at least one signal switching unit that has at least one signal switching element that can be actuated at least for the purpose of activating a drive unit of a power tool, having at least one operating-mode selection unit that has at least one operating-mode selection element that can be actuated for the purpose of selecting an operating mode of the drive unit, and having at least one locking unit that has at least one locking actuating element at least for locking the signal switching element.

It is proposed that the power-tool device comprise at least one electronic unit that is designed to control the drive unit, by open-loop and/or closed-loop control, at least in dependence on an evaluation of a position characteristic of the locking actuating element.

The power-tool device is realized, in particular, as a hand-held power-tool device, preferably as an electric hand-held power-tool device. In particular, the power-tool device is designed for use in a hand-held power tool, preferably in an electric hand-held power tool, and particularly preferably in a hammer drill and/or chiseling hammer. The signal switching unit is preferably arranged on a housing unit of the hand-held power tool. In particular, the signal switching element may be movably mounted. Preferably, the signal switching element is realized as a pushbutton switch, as a slide switch, as a toggle switch, as a sensor switch, or as another signal switching element considered appropriate by persons skilled in the art. In particular, an actuation of the signal switching element can cause at least two mutually different position characteristics of the signal switching element to be set. The position characteristic of the signal switching element may be realized, in particular, as a physical position of the signal switching element, in particular relative to the housing unit, as an electrical and/or electronic signal relating to an actuation state of the signal switching element, or as another characteristic of the signal switching element considered appropriate by persons skilled in the art. Preferably, the drive unit, in particular at least an electric motor of the drive unit, of the power tool is controlled, by open-loop and/or closed-loop control, in particular activated, by the electronic unit in dependence on an evaluation of the position characteristic. Preferably, the signal switching unit provides the electronic unit with the position characteristic of the signal switching element in the form of an electrical, or electronic, signal.

Preferably, the electronic unit has at least one electrical switching element such as, for example, a semiconductor switch or the like, for controlling the drive unit by open-loop and/or closed-loop control, in particular on the basis of the position characteristic of the signal switching element. An “electronic unit” is to be understood to mean, in particular a unit having at least one set of control electronics. A “set of control electronics” is to be understood to mean, in particular, a unit have a processor unit and having a memory unit, and having an operating program stored in the memory unit.

The operating-mode selection element is preferably arranged on the housing unit of the hand-held power tool. In particular, the operating-mode selection element may be mounted in a movable, preferably rotatable, manner. Preferably, the operating-mode selection element is realized as a selector wheel, as a slide switch, as a toggle switch, as a sensor selector element, or as another operating-mode selection element considered appropriate by persons skilled in the art. In particular, differing physical positions of the operating-mode selection element, in particular relative to the housing unit, and/or differing actuation states of the operating-mode selection element, are assigned to differing operating modes of the drive unit, in particular a percussion mechanism of the drive unit. In particular, the percussion mechanism of the drive unit is driven by the electric motor of the drive unit. In particular, the percussion mechanism of the drive unit drives an insert tool of the power tool. Preferably, the percussion mechanism of the drive unit has at least two differing operating modes. In particular, a percussion mechanism of a drive unit of a hammer drill and/or chiseling hammer has at least one hammer-drill operating mode and at least one chiseling-hammer operating mode. Preferably, in the hammer-drill operating mode, an insert tool of the hammer drill and/or chiseling hammer, such as, for example, a drill bit or the like, is driven by the percussion mechanism of the drive unit to effect a translational motion at least substantially parallel to a direction of main extent of the insert tool, and simultaneously to effect a rotational motion about the direction of main extent of the insert tool. Preferably, in the chiseling-hammer operating mode, the insert tool is driven translationally by the percussion mechanism of the drive unit, at least substantially without rotation, along the direction of main extent of the insert tool. A “direction of main extent” of an object is to be understood here to mean, in particular, a direction parallel to a longest edge of a smallest geometric cuboid that only just completely encompasses the object. Preferably, the electronic unit is designed to control the drive unit, in particular the percussion mechanism of the drive unit, by open-loop and/or closed-loop control, in dependence on an evaluation of the selected operating mode. Preferably, the operating-mode selection unit provides the electronic unit with the selected operating mode in the form of an electrical, or electronic, signal. “Designed” is to be understood to mean, in particular, specially programmed, configured and/or equipped. That an object is designed for a particular function is to be understood to mean, in particular, that the object fulfils and/or executes this particular function in at least one application state and/or operating state.

The locking actuating element is preferably arranged on the housing unit of the hand-held power tool. In particular, the locking actuating element may be movably mounted. Preferably, the locking actuating element is realized as a pushbutton switch, as a slide switch, as a toggle switch, as a sensor element, or as another locking actuating element considered appropriate by persons skilled in the art. Preferably, the locking actuating element is designed to lock the signal switching element mechanically, in particular by force closure and/or form closure. In particular, for the purpose of locking the signal switching element, the locking actuating element, preferably a latching extension of the locking actuating element, may engage in a latching recess of the signal switching element and, in particular, mechanically lock the signal switching element. Preferably, a movement of a locked signal switching element is blocked, at least substantially. Alternatively or additionally, it is conceivable for the locking unit to be designed to maintain electronically, preferably irrespective of a position of the signal switching element, in particular via the electronic unit, an operating state of the drive unit, in particular of the electric motor of the drive unit, set by actuation of the signal switching element. The position characteristic of the locking actuating element may be realized, in particular, as a physical position of the locking actuating element, in particular relative to the housing unit, as an electrical and/or electronic signal relating to an actuation state of the signal switching element, or as another characteristic of the signal switching element considered appropriate by persons skilled in the art. Preferably, the locking unit provides the electronic unit with the position characteristic of the locking actuating element in the form of an electrical, or electronic, signal. Preferably, the electronic unit is designed to control the drive unit, by open-loop and/or closed-loop control, in dependence on an evaluation of the position characteristic of the locking actuating element, the selected operating mode and the position characteristic of the signal switching element. In particular, the electronic unit is designed to activate the drive unit in the case of a position characteristic of the signal switching element that is associated with activation of the drive unit, in particular of the electric moor of the drive unit, in the case of a chiseling-hammer operating mode having been selected, and in the case of a position characteristic of the locking actuating element that is associated with locking of the signal switching element. Preferably, an operating state to be set for the drive unit, in particular for the electric motor of the drive unit, is stored in the memory unit of the electronic unit for each combination of the position characteristic of the locking actuating element, the selected operating mode and the position characteristic of the signal switching element. In particular, the electronic unit is designed to deactivate the drive unit in the case of a position characteristic of the signal switching element that is associated with activation of the drive unit, in particular of the electric motor of the drive unit, in the case of a hammer-drill operating mode having been selected, and in the case of a position characteristic of the locking actuating element that is associated with locking of the signal switching element.

The design of the power-tool device according to the invention advantageously enables a drive unit of a power tool to be controlled, by open-loop and/or closed-loop control, in dependence on an evaluation of a position characteristic of a locking actuating element. Advantageously, there is no need for an elaborate mechanism between the locking actuating element and a signal switching element. Advantageously, mechanical load on components of a locking unit and of a signal switching unit can be reduced, and a power-tool device having an advantageously long service life can be provided. An advantageously low-cost and compactly designed power-tool device can be provided.

It is furthermore proposed that the locking unit have at least one locking switching element that is operatively connected to the locking actuating element and that is designed to provide the electronic unit with the position characteristic of the locking actuating element. In particular, a mechanical locking actuating element is operatively connected to the locking switching element, preferably via a locking mechanism. Preferably, the locking switching element is connected in an electrically conductive manner to the electronic unit. Preferably, the locking switching element is designed to close or open an electrical circuit, that comprises the electronic unit, in dependence on the position of the locking actuating element. In particular, an electric current flow to the electronic unit is effected, or an electric current flow to the electronic unit is interrupted, in dependence on the position of the locking actuating element. Preferably, the locking switching element provides the electronic unit with the position characteristic of the locking actuating element in the form of an electrical signal. In particular, an actuation of the locking actuating element causes a force to be exerted upon the locking switching element, thereby preferably causing the electrical circuit comprising the electronic unit to be closed or opened by the locking switching element. Preferably, an operative connection between the locking actuating element and the locking switching element is realized in such a manner that, upon an actuation of the locking actuating element for the purpose of locking the signal switching element, the electrical circuit comprising the electronic unit is closed by the locking switching element. Preferably, the operative connection between the locking actuating element and the locking switching element is realized in such a manner that, upon an actuation of the locking actuating element for the purpose of unlocking the signal switching element, the electrical circuit comprising the electronic unit is opened by the locking switching element. Alternatively, it is conceivable for the operative connection between the locking actuating element and the locking switching element to be realized in such a manner that, upon an actuation of the locking actuating element for the purpose of locking the signal switching element, the electrical circuit comprising the electronic unit is opened by the locking switching element and that, upon an actuation of the locking actuating element for the purpose of unlocking the signal switching element, the electrical circuit comprising the electronic unit is closed by the locking switching element. Advantageously, the electronic unit may be provided with the position characteristic of the locking actuating element in the form of an electrical signal. Advantageously, there is no need for an elaborate mechanism for providing the position characteristic. Advantageously, it is possible to provide an inexpensive power-tool device that has a long service life.

It is additionally proposed that the operating-mode selection unit have at least one operating-mode switching element that is operatively connected to the operating-mode selection element and that is designed to provide the electronic unit with a signal relating to the selected operating mode. In particular, a mechanical operating-mode selection element is operatively connected to the operating-mode switching element. Preferably, the operating-mode switching element is designed to provide the electronic unit with an electrical signal regarding the selected operating mode. Preferably, the operating-mode switching element is connected in an electrically conductive manner to the electronic unit. Preferably, the operating-mode switching element may be realized as a switch, in particular in the case of only two operating modes that can be selected by means of the operating-mode actuating element. In particular, in the case of a plurality of operating modes that can be selected by means of the operating-mode selection element, the operating-mode switching element may preferably be realized as a switch having a plurality of switching positions, as a potentiometer, or as another operating-mode switching element considered appropriate by persons skilled in the art. Preferably, an operative connection between the operating-mode selection element and the operating-mode switching element is realized in such a manner that differing electrical currents, switched by the operating-mode selection element, flow to the electronic unit in dependence on a position of the operating-mode selection element, corresponding to a selected operating mode. Advantageously, there is no need for an elaborate mechanism for providing a signal relating to a selected operating mode. Advantageously, it is possible to provide an inexpensive power-tool device that has a long service life.

It is furthermore proposed that the signal switching unit, for the purpose of providing a position characteristic of the signal switching element, is designed to switch electrical currents having amperages of less than or equal to 500 mA. Preferably, the signal switching unit has a signal switching contact, in particular operatively connected to the signal switching element. Preferably, the signal switching contact is connected in an electrically conductive manner to the electronic unit. In particular, the signal switching contact designed to provide the electronic unit with the position characteristic of the signal switching element in the form of an electrical signal. Preferably, an operative connection between the signal switching element and the signal switching contact is realized in such a manner that an electrical circuit comprising the electronic unit is opened or closed by the signal switching contact. In particular, in the case of a closed electrical circuit comprising the electronic unit, only an electrical current having an amperage of not more than 500 ma, preferably of not more than 250 mA, and particularly preferably of not more than 100 mA, flows via the signal switching contact. In particular, the electrical switching element of the electronic unit is realized in such a manner that, in particular for the purpose of activating or deactivating the drive unit, in particular the electric motor of the drive unit, electrical currents having amperages of not more than 500 mA can be detected by the electrical switching element. Advantageously, there is no need for electrical current to be conducted and/or switched, corresponding to a power of the drive unit, in particular the electric motor of the drive unit, by the signal switching unit. It is advantageously possible to provide a power-tool device that has a long service life.

It is also proposed that the locking unit be designed to lock the signal switching element in an unactuated state of the signal switching element. Preferably, the locking actuating element is designed to mechanically block the signal switching element in an unactuated state of the signal switching element. In particular, mechanical blocking of the signal switching element prevents actuation of the signal switching element. Alternatively or additionally, it is conceivable for the locking unit to be designed to maintain electronically, preferably irrespective of a position of the signal switching element, in particular via the electronic unit, a deactivation of the drive unit set by an unactuated switching element. Advantageously, unintentional starting of a power tool can be prevented. Advantageously, there is no need for a a separate locking element for locking the signal switching element in an unactuated state of the signal switching element. A user-safe and compactly designed power-tool device can be provided.

It is furthermore proposed that the signal switching element can only be unlocked by means of the locking unit. In particular, the signal switching element can be unlocked by an actuation of the locking actuating element. Preferably, the locking unit is designed to maintain a locking of the signal switching element irrespective of an actuation of the signal switching element. Advantageously, unintentional unlocking of the signal switching element, in particular resulting from inadvertent actuation of the signal switching element, can be avoided, at least substantially. Advantageously, a user-safe power-tool device can be provided.

It is additionally proposed that the locking unit be realized as a bistable locking unit. In particular, the locking unit has a bistable locking mechanism. Preferably, the bistable locking mechanism is connected to the, in particular mechanical, locking actuating element and to the locking switching element. In particular, the bistable locking mechanism has precisely two stable states. A first stable state of the bistable locking mechanism preferably corresponds to a locking of the signal switching element. A second stable state of the bistable locking mechanism preferably corresponds to an unlocking of the signal switching element. In particular, the bistable locking mechanism can change from one of the two stable state to another of the two stable states as a result of an actuation of the locking actuating element. Preferably, the bistable locking mechanism may be realized as ballpoint-pen mechanism, as a bistable slide mechanism, as a bistable rocker mechanism, or as another bistable locking mechanism considered appropriate by persons skilled in the art. Advantageously, a locking or unlocking of the signal switching element can be maintained even if the locking actuating element is released following an actuation. It is advantageously possible to provide a user-safe power-tool device that is also convenient to use.

It is furthermore proposed that the locking unit be designed to maintain the locking of the signal switching element irrespective of the operating mode. In particular, the locking unit is designed to maintain the, in particular mechanical, locking of the signal switching element in the case of a hammer-drill operating mode having been selected. Preferably, the electronic unit is designed to control the drive unit, by open-loop and/or closed-loop control, in dependence on an evaluation of the position characteristic of the signal switching element, the selected operating mode and the position characteristic of the locking actuating element. In particular, the electronic unit is designed to deactivate the drive unit in the case of a hammer-drill operating mode having been selected and the signal switching element having been locked. Advantageously, there is no need for mechanical unlocking of the signal switching element, even in the case of a hammer-drill operating mode having been selected. Advantageously, there is no need for an elaborate mechanism for automatic unlocking of the signal switching element. Advantageously, an inexpensive power-tool device can be provided.

It is also proposed that the signal switching unit have at least one speed transducer unit, which is operatively connected to the signal switching element, for regulating a rotational speed of the drive unit. In particular, the speed transducer unit is designed to regulate a rotational speed of the electric motor of the drive unit. The speed transducer unit may preferably be realized as a potentiometer, or as another speed transducer unit considered appropriate by persons skilled in the art. Preferably, the speed transducer unit is operatively connected mechanically to the signal switching element. Alternatively, it is conceivable, in particular if the signal switching element is realized as a sensor switching element or the like, for the speed transducer unit to be operatively connected to the signal switching element electrically, or electronically. Preferably, the speed transducer unit is connected in an electrically conductive manner to the electronic unit. In particular, an operative connection between the signal switching element and the speed transducer unit is realized in such a manner that the speed transducer unit provides the electronic unit with an electrical signal such as, for example, a voltage, an electrical current, or the like, in dependence on a position of the signal switching element, that preferably is proportional to a position of the signal switching element. Preferably, differing electrical signals are assigned to differing rotational speeds of the drive unit, in particular of the electric motor of the drive unit. Preferably, the locking unit may be realized in such a manner that the signal switching element can be locked in differing positions, corresponding to differing rotational speeds of the drive unit, in particular of the electric motor of the drive unit. Advantageously, it is possible to provide a power-tool device that, by means of a lockable signal switching element, has a variable-speed function.

The invention is additionally based on a power tool, in particular a hand-held power tool, having at least one power-tool device according to the invention. Preferably, the power tool can be operated with electrical energy. In particular, the power tool comprises the drive unit, which preferably comprises at least one electric motor and a percussion mechanism. Preferably, the power tool comprises other component parts, in particular necessary for operation of the power tool. In particular, the power tool may comprise at least one energy supply unit such as, for example, an accumulator battery, a mains power cable, or the like, a tool chuck, a housing and/or other components considered appropriate by persons skilled in the art. In particular, the power tool has a mass of less than 40 kg, preferably less than 10 kg, and particularly preferably less than 5 kg. The power tool is preferably realized as a hammer drill and/or chiseling hammer. Alternatively, it is conceivable for the power tool to be realized as a jigsaw, as a power drill, as an angle grinder, or as another power tool considered appropriate by persons skilled in the art. It is advantageously possible to provide a compact, inexpensive and/or user-safe power tool that has a long service life.

The power-tool device according to the invention and/or the power tool according to the invention are not intended in this case to be limited to the application and embodiment described above. In particular, the power-tool device according to the invention and/or the power tool according to the invention may have individual elements, component parts and units, and method steps, that differ in number from a number stated herein, in order to fulfill an operating principle described herein. Moreover, in the case of the value ranges specified in this disclosure, values lying within the stated limits are also to be deemed as disclosed and applicable in any manner.

### DRAWING

Further advantages are given by the following description of the drawing. The drawing shows an exemplary embodiment of the invention. The drawing, the description and the claims contain numerous features in combination. Persons skilled in the art will expediently also consider them individually and combine them to form appropriate further combinations.

There are shown:

FIG. 1 a power tool according to the invention, in a schematic representation,

FIG. 2 a power-tool device according to the invention, in a schematic representation,

FIG. 3 a part of the power-tool device with a signal switching element locked in an actuated state, in a schematic representation,

FIG. 4 the part of the power-tool device with a signal switching element locked in an unactuated state, in the schematic representation,

FIG. 5 a part of the power-tool device with a signal switching element unlocked in an unactuated stated, in an alternative schematic representation,

FIG. 6 the part of the power-tool device with a signal switching element locked in an unactuated state, in the alternative schematic representation,

FIG. 7 the part of the power-tool device with a signal switching element unlocked in an actuated state, in the alternative schematic representation, and

FIG. 8 the part of the power-tool device with a signal switching element locked in an actuated state, in the alternative schematic representation.

### DESCRIPTION OF THE EXEMPLARY EMBODIMENTS

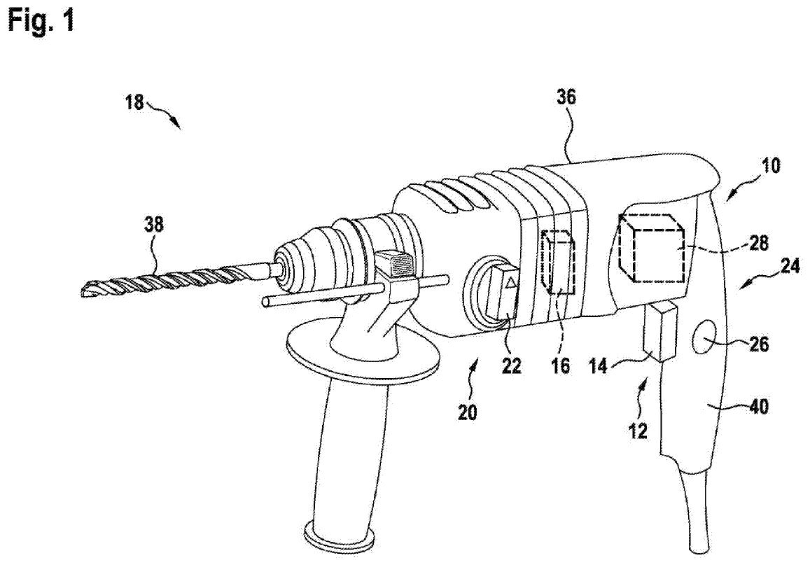

FIG. 1 shows a power tool 18 in a schematic representation. The power tool 18 is realized as a hand-held power tool. The power tool 18 is realized as a hammer drill and/or chiseling hammer. The power tool 18 has a housing unit 36. The power tool 18 has a drive unit 16. The drive unit 16 is arranged within the housing unit 36. The drive unit 16 comprises an electric motor and a percussion mechanism. The drive unit 16 is designed to drive an insert tool 38 of the power tool 18. The insert tool 38 is realized as a drill bit. The power tool 18 comprises a power-tool device 10. The power-tool device 10 comprises a signal switching unit 12. The signal switching unit 12 has a signal switching element 14. The signal switching element 14 can be actuated for the purpose of activating the drive unit 16 of the power tool 18. The signal switching element 14 can be actuated for the purpose of activating the electric motor of the drive unit 16 of the power tool 18. The signal switching element 14 is arranged on a handle 40 of the power tool 18. The signal switching element 14 is realized as a pushbutton switch. The power-tool device 10 comprises an operating-mode selection unit 20. The operating-mode selection unit 20 has an operating-mode selection element 22. The operating-mode selection element 22 can be actuated for the purpose of selecting an operating mode of the drive unit 16. The operating-mode selection element 22 can be actuated for the purpose of selecting an operating mode of the percussion mechanism of the drive unit 16. The operating-mode selection element 22 is arranged on the housing unit 36. The operating-mode selection element 22 is realized as a rotary switch. The operating-mode selection unit 20 can be used to switch over between a hammer-drill operating mode and a chiseling-hammer operating mode. The power-tool device 10 comprises a locking unit 24. The locking unit 24 has a locking actuating element 26. The locking actuating element 26 is designed at least to lock the signal switching element 14. The locking actuating element 26 is arranged on the handle 40. The locking actuating element 26 is arranged substantially perpendicularly in relation to the signal switching element 14, on the handle 40. The locking actuating element 26 is arranged on a lateral face of the handle 40. Alternatively, it is conceivable for the locking actuating element 26 to be arranged on an upper side of the handle 40. The expression “substantially perpendicularly” is intended here to define, in particular, an alignment of a direction relative to a reference direction, the direction and the reference direction, in particular as viewed in one plane, enclosing an angle of 90°, and the angle having a maximum deviation of, in particular, less than 8°, advantageously less than 5°, and particularly advantageously less than 2°. The locking actuating element 26 is realized as a pushbutton switch. The power-tool device 10 comprises an electronic unit 28. The electronic unit 28 is designed to evaluate a position characteristic of the locking actuating element 26. The electronic unit 28 is designed to control the drive unit 16, by open-loop and/or closed-loop control, at least in dependence on the evaluation of the position characteristic of the locking actuating element 26. The electronic unit 28 is designed to control the drive unit 16, by open-loop and/or closed-loop control, in dependence on an evaluation of a position characteristic of the signal switching element 14, a selected operating mode and the position characteristic of the locking actuating element 26. The electronic unit 28 is arranged within the housing unit 36.

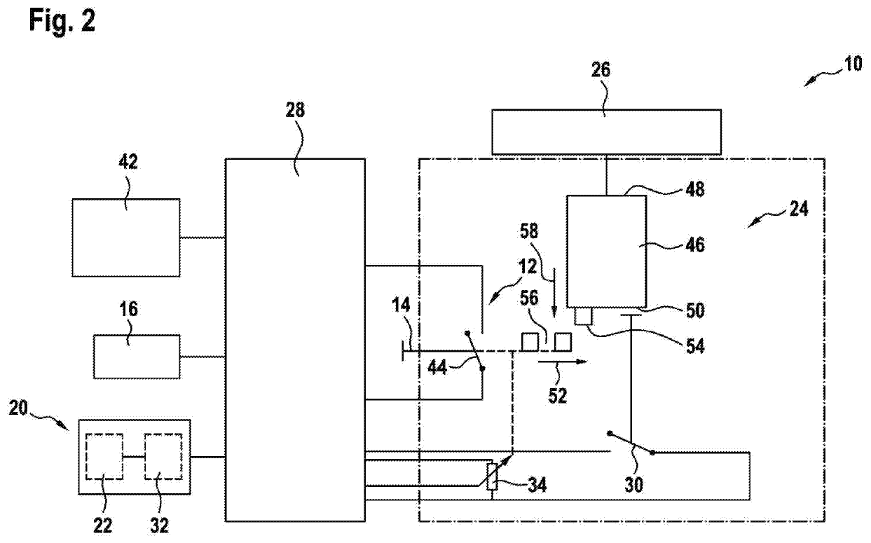

FIG. 2 shows the power-tool device 10 in a schematic representation. The power-tool device 10 comprises the signal switching unit 12, the operating-mode selection unit 20, the locking unit 24 and the electronic unit 28. An energy supply unit 42 of the power tool 18 is connected in an electrically conductive manner to the electronic unit 28. The energy supply unit 42 is realized as a mains power supply. Alternatively, it is conceivable for the energy supply unit 42 to be realized as an accumulator battery. The drive unit 16 of the power tool 18 is connected in an electrically conductive manner to the electronic unit 28. The locking unit 24 has a locking switching element 30. The locking switching element 30 is operatively connected to the locking actuating element 26. The locking switching element 30 is mechanically coupled to the locking actuating element 26. The locking switching element 30 is mechanically coupled to the locking actuating element 26 via a bistable locking mechanism 46 of the locking unit 24. The locking switching element 30 is realized as an electrical switching contact. The locking switching element 30 is designed to provide the electronic unit 28 with the position characteristic of the locking actuating element 26. The locking switching element 30 is connected in an electrically conductive manner to the electronic unit 28. The locking switching element 30 provides the electronic unit 28 with the position characteristic in the form of an electrical signal. The locking actuating element 26 and the locking switching element 30 are each represented in an unactuated state.

The operating-mode selection unit 20 has an operating-mode switching element 32. The operating-mode switching element 32 is operatively connected to the operating-mode selection element 22. The operating-mode switching element 32 is mechanically coupled to the operating-mode selection element 22. The operating-mode switching element 32 is realized as an electrical switching contact. The operating-mode switching element 32 is designed to provide the electronic unit 28 with a signal relating to the selected operating mode. The operating-mode switching element 32 is connected in an electrically conductive manner to the electronic unit 28. The operating-mode switching element 32 provides the electronic unit 28 with an electrical signal relating to the selected operating mode.

The signal switching unit 12 is designed to provide a position characteristic of the signal switching element 14 for the purpose of switching electrical currents having amperages of less than or equal to 500 mA. The signal switching unit 12 has an electrical signal switching contact 44. The electrical signal switching contact 44 is operatively connected to the signal switching element 14. The electrical signal switching contact 44 is mechanically coupled to the signal switching element 14. The electrical signal switching contact 44 is connected in an electrically conductive manner to the electronic unit 28. The electrical signal switching contact is designed to provide the electronic unit 28 with the position characteristic of the signal switching element 14 in the form of an electrical signal. An operative connection between the signal switching element 14 and the electrical signal switching contact 44 is realized in such a manner that an electrical circuit comprising the electronic unit 28 is opened or closed by the electrical signal switching contact 44. In the case of a closed electrical circuit comprising the electronic unit 28, only an electrical current having an amperage of not more than 500 mA flows via the signal switching contact 44. The electronic unit 28 has an electrical switching element, not represented further, which controls the drive unit 16, by open-loop and/or closed-loop control, in dependence on the position characteristic of the signal switching element 14. The electrical switching element of the electronic unit 28 is realized in such a manner that electrical currents having amperages of not more than 500 mA can be detected. The signal switching element 14 and the electrical signal switching contact 44 are each represented in an unactuated state.

The locking unit 24 is realized as a bistable locking unit. The locking unit 24 has a bistable locking mechanism 46. The bistable locking mechanism 46 is operatively connected to the locking actuating element 26, on a first side 48 of the bistable locking mechanism 46. The bistable locking mechanism 46 is mechanically coupled to the locking actuating element 26, on the first side 48. The bistable locking mechanism 46 is connected to the locking switching element 30 on a second side 50 of the bistable locking mechanism 46 that faces away from the first side 48. Alternatively, it is conceivable for the locking actuating element 26 to be arranged on a side of the locking mechanism 46 that is substantially perpendicular to the first side 48, or on the first side 48. The bistable locking mechanism 46 is mechanically coupled to the locking actuating element 26 on the second side 50. The bistable locking mechanism 46 effects the operative connection between the locking actuating element 26 and the locking switching element 30. The bistable locking mechanism 46 has precisely two stable states. A first stable state of the bistable locking mechanism 46 corresponds to a locking of the signal switching element 14. A second stable state of the bistable locking mechanism 46 corresponds to an unlocking of the signal switching element 14. The bistable locking mechanism 46 can change from one of the two stable state to another of the two stable states as a result of an actuation of the locking actuating element 26. The bistable locking mechanism 46 is realized as a ballpoint-pen mechanism. Alternatively, it is conceivable for the bistable locking mechanism 46 to be realized as a bistable slide mechanism or as a bistable rocker mechanism.

The signal switching unit 12 has a speed transducer unit 34. The speed transducer unit 34 is operatively connected to the signal switching element 14. The speed transducer unit 34 is mechanically coupled to the signal switching element 14. The speed transducer unit 34 is designed to regulate a rotational speed of the drive unit 16. The speed transducer unit 34 is designed to regulate a rotational speed of the electric motor of the drive unit 16. The speed transducer unit 34 is connected in an electrically conductive manner to the electronic unit 28. An operative connection between the signal switching element 14 and the speed transducer unit 34 is realized in such a manner that the speed transducer unit 34 provides the electronic unit 28 with an electrical signal in dependence on a position of the signal switching element 14. The speed transducer unit 34 provides the electronic unit 28 with an electrical signal that is proportional to a position of the signal switching element 14. Differing electrical signals are assigned to differing rotational speeds of the electric motor of the drive unit 16. The locking unit 24 is realized in such a manner that the signal switching element 14 can be locked in a position of the signal switching element 14 corresponding to a deactivated drive unit 16, and in a position of the signal switching element 14 corresponding to a maximum rotational speed of the electric motor of the drive unit 16. In principle, however, it is conceivable for the locking unit 24 to be realized in such a manner that the signal switching element 14 can be locked in a plurality of differing positions, corresponding to a plurality of differing rotational speeds of the electric motor of the drive unit 16.

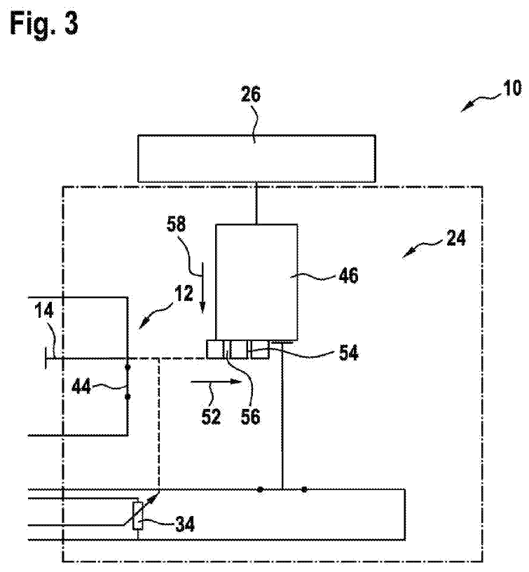

FIG. 3 shows a part of the power-tool device 10 with a signal switching element 14 locked in an actuated state, in a schematic representation. The actuated state of the signal switching element 14 corresponds to a displacement of the signal switching element 14 along a first direction 52, as compared to an unactuated state of the signal switching element 14. The electrical signal switching contact 44 is closed, and provides the electronic unit 28, not represented further, with the position characteristic of the signal switching element 14. The signal switching element 14 is locked by the locking actuating element 26. A latching extension 54 of the locking actuating element 26 engages in a latching recess 56 of the signal switching element 14. A movement of the signal switching element 14 contrary to the first direction 52 is blocked by the locking actuating element 26. The locking switching element 30 is closed, and provides the electronic unit 28, not represented further, with the position characteristic of the locking actuating element 26. The signal switching element 14 can be unlocked only by means of the locking unit 24. The signal switching element 14 can be unlocked by an actuation of the locking actuating element 26. The latching extension 54 can be moved out of the latching recess 56, contrary to a second direction 58, by an actuation of the locking actuating element 26. A movement of the signal switching element 14, contrary to the first direction 52, is released. The locking unit 24 is designed to maintain the locking of the signal switching element 14 irrespective of the operating mode. In the case of a hammer-drill operating mode having been selected, the signal switching element 14 remains in the actuated and locked state. In the case of the hammer-drill operating mode having been selected, the electronic unit 28 deactivates the drive unit 16 on the basis of the evaluation of the selected operating mode, the position characteristic of the signal switching element 14 and the position characteristic of the locking actuating element 26.

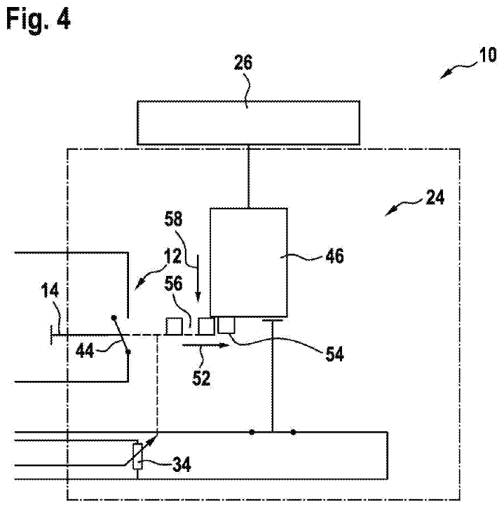

FIG. 4 shows the part of the power-tool device 10 with a signal switching element 14 locked in an unactuated state, in the schematic representation. The electrical signal switching element 14 is open. The electronic unit 28 is provided with the position characteristic of the signal switching element 14 in the form of an electrical zero signal. The locking unit 24 is designed to lock the signal switching element 14 in an unactuated state of the signal switching element 14. The signal switching element 14 is locked by the locking actuating element 26. The latching extension 54 of the locking actuating element 26 blocks the signal switching element 14. A movement of the signal switching element 14 along the first direction 52 is blocked by the locking actuating element 26. The locking switching element 30 is closed, and provides the electronic unit 28 with the position characteristic of the locking actuating element 26.

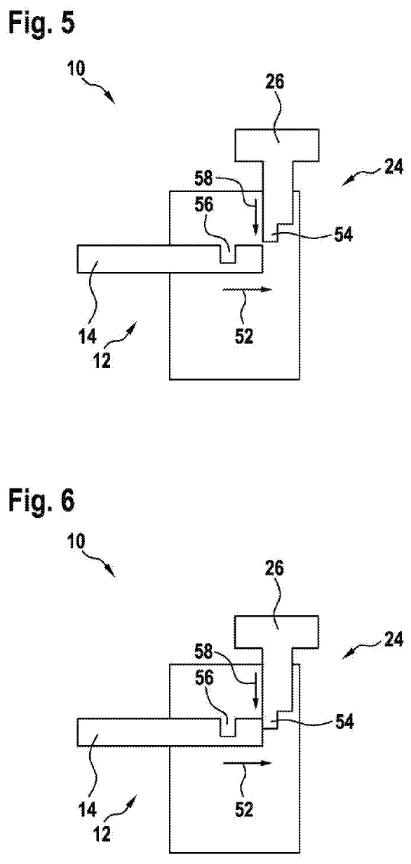

FIG. 5 shows a part of the power-tool device 10 with a signal switching element 14 unlocked in an unactuated state, in an alternative schematic representation. The part of the power-tool device 10 is represented in a simplified form. For reasons of clarity, the bistable locking mechanism 46, the locking switching element 30, the electrical signal switching contact 44 and the speed transducer unit 34 are not represented. The locking actuating element 26 of the locking unit 24 is in an unactuated state. The signal switching element 14 of the signal switching unit 12 is freely movable. The signal switching element 14 can be moved along the first direction 52.

FIG. 6 shows the part of the power-tool device 10 with a signal switching element 14 locked in an unactuated state, in the alternative schematic representation. The locking actuating element 26 of the locking unit 24 is in an actuated state. The latching extension 54 of the locking actuating element 26 has been displaced along the second direction 58, as compared with an unactuated state of the locking actuating element 26. A movement of the signal switching element 14 of the signal switching unit 12 along the first direction 52 is blocked by the locking actuating element 26.

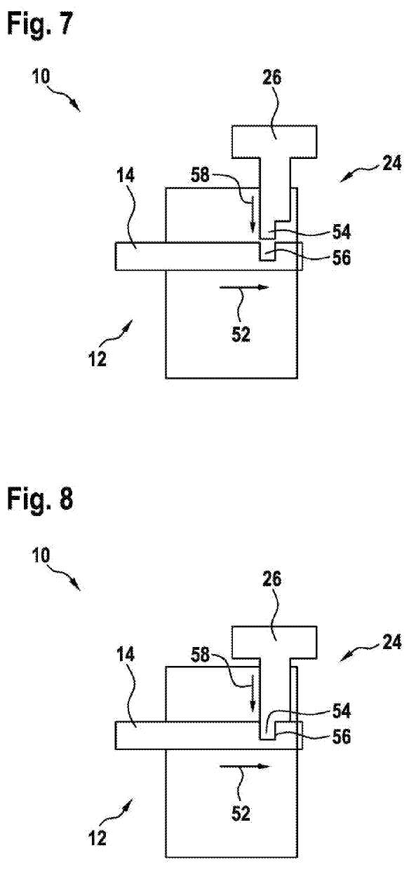

FIG. 7 shows the part of the power-tool device 10 with a signal switching element 14 unlocked in an actuated state, in the alternative schematic representation. The locking actuating element 26 of the locking unit 24 is in an unactuated state. The signal switching element 14 of the signal switching unit 12 is freely movable. The signal switching element 14 can be moved contrary to the first direction 52.

FIG. 8 shows the part of the power-tool device 10 with a signal switching element 14 locked in an actuated state, in the alternative schematic representation. The locking actuating element 26 of the locking unit 24 is in an actuated state. The latching extension 54 of the locking actuating element 26 has been displaced along the second direction 58, as compared with an unactuated state of the locking actuating element 26. The latching extension 54 engages in the latching recess 56 of the signal switching element 14 of the signal switching unit 12. A movement of the signal switching element 14 contrary to the first direction 52 is blocked by the locking actuating element 26.

1. A power-tool device, comprising:
a drive unit;
at least one signal switching unit including at least one signal switching element configured to be actuated at least to activate the drive unit;
at least one operating-mode selection unit including at least one operating-mode selection element configured to be actuated to select an operating mode of a plurality of operating modes of the drive unity;
at least one locking unit including at least one locking actuating element configured to lock the at least one signal switching element; and
at least one electronic unit configured to control the drive unit, by open-loop and/or closed-loop control, at least in dependence on an evaluation of a position characteristic of the at least one locking actuating element.

2. The power-tool device as claimed in claim 1, wherein the at least one locking unit further including at least one locking switching element that is operatively connected to the at least one locking actuating element and that is configured to provide the at least one electronic unit with the position characteristic of the at least one locking actuating element.

3. The power-tool device as claimed in claim 1, wherein the at least one operating-mode selection unit further including at least one operating-mode switching element that is operatively connected to the at least one operating-mode selection element and that is configured to provide the at least one electronic unit with a signal relating to the selected operating mode of the drive unit.

4. The power-tool device as claimed in claim 1, wherein the at least one signal switching unit, for providing the position characteristic of the at least one signal switching element, is configured to switch electrical currents having amperages of less than or equal to 500 mA.

5. The power-tool device as claimed in claim 1, wherein the at least one locking unit is configured to lock the at least one signal switching element in an unactuated state of the at least one signal switching element.

6. The power-tool device as claimed in claim 1, wherein only the at least one locking unit is configured to unlock the at least one signal switching element.

7. The power-tool device as claimed in claim 1, wherein the at least one locking unit is configured as a bistable locking unit.

8. The power-tool device as claimed in claim 1, wherein the at least one locking unit is configured to maintain locking of the at least one signal switching element irrespective of the operating mode of the drive unit.

9. The power-tool device as claimed in claim 1, wherein the at least one signal switching unit has at least one speed transducer unit, which is operatively connected to the at least one signal switching element and is configured to regulate a rotational speed of the drive unit.

10. A power tool, comprising:
at least one power-tool device including:
a drive unit;
at least one signal switching unit including at least one signal switching element configured to be actuated at least to activate the a drive unit;
at least one operating-mode selection unit including at least one operating-mode selection element configured to be actuated to select an operating mode of a plurality of operating modes of the drive unit;
at least one locking unit including at least one locking actuating element configured to lock the at least one signal switching element and
at least one electronic unit configured to control the drive unit, by open-loop and/or closed-loop control, at least in dependence on an evaluation of a position characteristic of the at least one locking actuating element.
